(19) United States
(12) Patent Application Publication
(10) Pub. No.: US 2024/0109438 A1
(43) Pub. Date: Apr. 4, 2024

(54) Autonomous Persistent Security

(71) Applicant: Ghost Robotics Corporation, Philadelphia, PA (US)

(72) Inventors: James Laney, Wayne, PA (US); Adam Doroski, Havertown, PA (US)

(21) Appl. No.: 18/231,844

(22) Filed: Aug. 9, 2023

Related U.S. Application Data
(60) Provisional application No. 63/396,303, filed on Aug. 9, 2022.

(51) Int. Cl. B60L 53/126; B25J 9/16; B60K 1/04; B60L 53/38; B62D 57/032

(52) U.S. Cl. CPC B60L 53/126; B25J 9/161; B60K 1/04; B60L 53/38; B62D 57/032

(57) ABSTRACT

The present invention discloses a wireless charging system for Q-UGVs, housed in a robust build. The wireless charging system is housed in a weatherproof box and is capable of charging more than one Q-UGV, thus baggage and fatigue of having to maintain multiple charging stations for multiple systems. An improvement in the system is expedited charging for two Q-UGVs, which is ideal environments wherein autonomous and persistent security is necessary and is capable of receiving and transmitting charging commands from the Q-UGV.

### CROSS REFERENCE TO RELATED APPLICATIONS

This application claims the benefit of U.S. Provisional Patent Application Ser. No. 63/396,303 filed on Aug. 9, 2022, the contents of which are incorporated herein by reference.

### BACKGROUND OF THE INVENTION

Territories comprised of vast expanses of land stretch for many miles, and much of it remains unguarded due to the sheer size of the land. The distance, remoteness and topography of the land often makes it difficult for Security Forces to patrol these terrains. One way to realistically guard these expanses is by providing 24/7 coverage of select borders or fence lines through Q-UGVs.

Q-UGVs are multi-legged unmanned ground vehicles. These types of vehicles are used in a plethora of environments but particularly capable for military, security and defense. Thus, Q-UGVs are very capable stand-ins for a 24/7 Security Force, as they are able to execute various tasks pertinent to defense and security such as target acquisition, surveillance among other preliminary surveys of large and/or unmanned lands.

Despite their exceptional capabilities in these environments, these vehicles still require charging to operate at optimal levels. It is imperative a system is in place to rapidly charge these vessels at a rate faster or equal to the rate of battery discharge of the robot, while in continuous operation. It is also equally imperative that these systems utilize wireless networks and provide real-time telemetry and control of the patrolling system.

### SUMMARY OF THE INVENTION

For large expanses of land that require patrolling, it can often be difficult for personnel to surveil the land 24/7 due to the sheer size of it. Q-UGVs help mitigate this by patrolling these territories by providing coverage of select borders or fence lines. In the present invention, multiple Q-UGVs can be services in these wireless charging docks.

The present invention takes the aforementioned urgencies into account and provides a wireless charging system housed in a weatherproof box with an automated door controlled by the Q-UGV over a wireless network. This wireless box is capable of serving multiple Q-UGVs. The present invention creates a system and method for charging multiple Q-UGVs in environments wherein autonomous and persistent security is ideal and is capable of receiving and transmitting commands from the Q-UGV.

The present invention's wireless charging docks are positioned accordingly to allow the Q-UGV to autonomously perform a dock sequence using the help of specifically designed passive fiducial marker to identify and estimate the position of the dock's interface saddle, allowing the Q-UGV to maneuver and straddle the dock before lowering its body onto the dock interface.

The fiducial is specifically designed to be seen from large distances and off-axis in various lighting conditions. This system provides accuracy of 2 cm or less final position error between the Q-UGV's battery interface and wireless charging dock interface. To provide the final alignment between the Q-UGV's battery and wireless charging dock interface, a special mechanical interface was designed to provide mechanical alignment to secure the battery interface onto the wireless charging dock interface.

On command, through a wireless network, the Q-UGV is able to, by way of example and not limitation, autonomously open the automated door, perform the undock sequence, close the automated door, initialize its position in GPS coordinates through the use of internal and/or external sensors, navigate a series of waypoints along the desired border or fence line, return to the doghouse, open the door, dock, close the door and begin charging. Additionally, the secondary Q-UGV can perform the same sequence.

Design considerations may be made to ensure the entire system can work day and night, in various weather and in various lighting conditions to increase system uptime. For example, the weatherproof enclosure of the charging system may be made with robust and durable materials, such as fiberglass, polycarbonate, and ABS plastic—in conjunction with protective chemical coatings for printed circuit boards. Other approaches such as nanocoating also may help create a barrier for undesirable weather conditions. The weatherproof box provides a standalone system for maintaining persistent operation of two Q-UGVs in all types of weather conditions, insulated and climate controlled to maintain safe temperatures for its lithium-ion batteries. The weatherproofed box comprises of at least 2 wireless charging docks, 2 localization fiducials, one 4G/LTE gateway, a single board computer, a powered door, a RTK GPS base station, an alternating current unit with a breaker panel and electrical disconnect, a heating unit and an overhead light. The box also supports a router and wireless communication system to interface with the Q-UGVs, which aid them in sending commands to a single board computer to control the opening of the door. The single board computer can execute and generate command instructions by way of a microprocessor, memory, or input and may operate on the same network as a Q-UGV and the wireless charging station.

To execute the autonomous persistent security operation, one of the two Q-UGVs can interface with the weatherproof charging and docking system independently without the commands from a remote operator. The autonomous execution models for a single robot include, by way of example and not limitation, receiving missions, turning off wireless, opening the door, beginning undocking, initializing GNSS, performing security patrols, and a complete mission module. Any one of these functions may be executed by at least one of the Q-UGVs, which receive instructions for charging and executing specific missions and operations.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 is a depiction of the wireless charging dock.

FIG. 2 is a depiction of the wireless battery affixed to a robot.

FIG. 3 is an exemplary autonomous persistent security operation diagram.

FIG. 4 is a depiction of the present invention's wireless charging dock.

The various embodiments are illustrated by way of example, and not by way of limitation, in the figures of the accompanying drawings. Having thus described the invention in general terms, reference will now be made to the accompanying drawings, which are not necessarily drawn to scale, and wherein:

### DETAILED DESCRIPTION OF THE PREFERRED EMBODIMENT

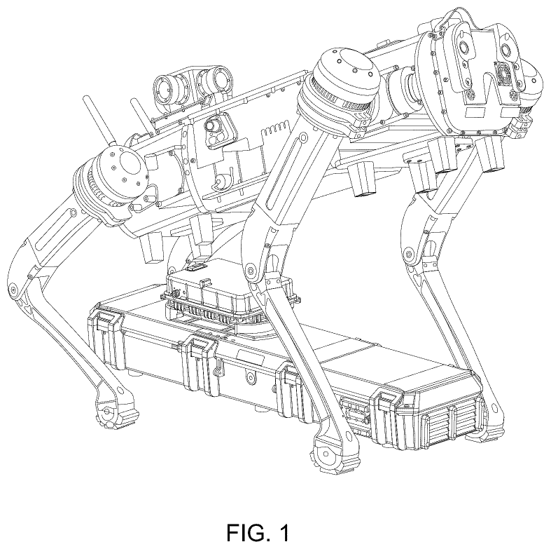

FIG. 1 is a depiction of the wireless charging dock. The wireless charging dock is a self-contained system accepting 110AC voltage and provides wireless charging capability through an RF transmitting coil located between the alignment features operating at 2.4 Ghz. The wireless charging dock receives commands from the Q-UGV via the installed wireless battery to signal to the transmitting coil to start or stop charging. The enclosure for the wireless charging dock uses a CoTs transport case and is weather resistant.

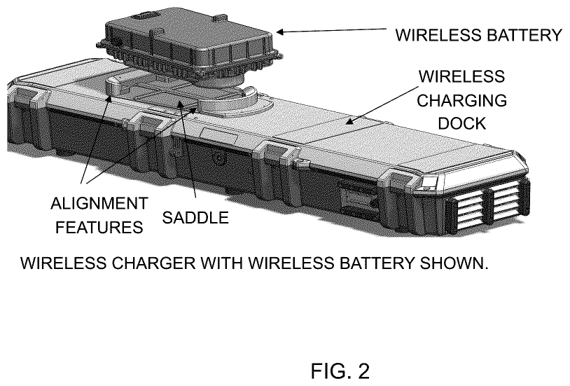

FIG. 2 is a depiction of the wireless battery affixed to a robot. The wireless battery is attached to the charging dock. The figure illustrates the connectivity between the wireless battery and the Q-UGV. While the Q-UGV does not need to be mounted atop the wireless battery, the purpose of the illustration is to depict the relationship between the wireless battery box and the Q-UGV.

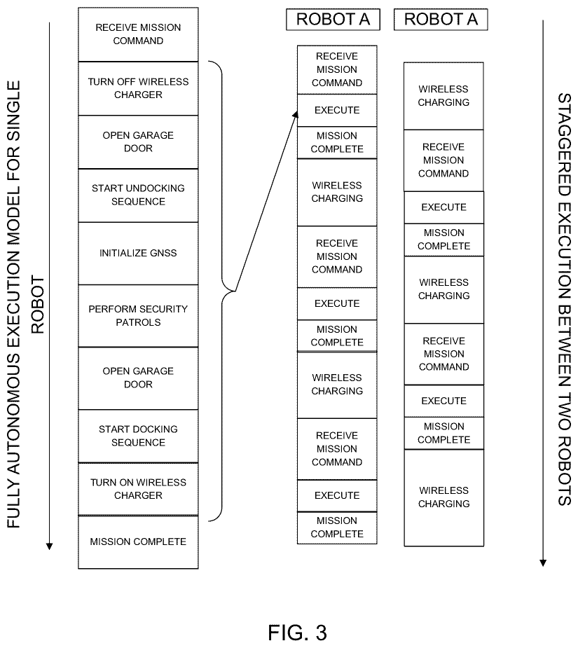

FIG. 3 is a diagram of autonomous persistent security operations. The autonomous execution models for a single robot include receive message, turn off wireless, open garage door, a start undocking model, initializing GNSS model, security patrolling model, and docking sequence in addition to a ‘mission complete’ execution model. The Q-UGV may receive and execute any one of these tasks, and wirelessly charge.

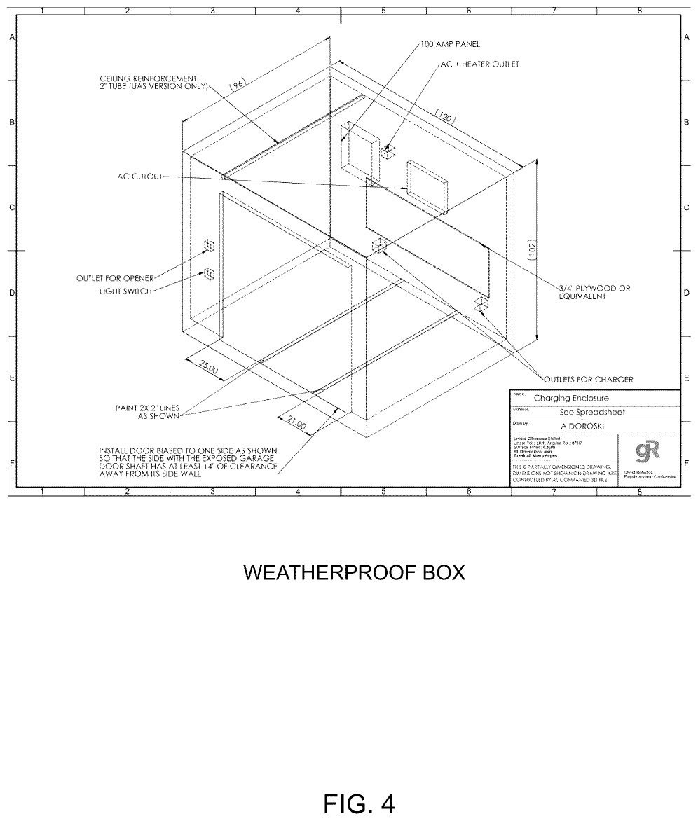

FIG. 4 is a depiction of the present invention's wireless charging dock enclosure. The enclosure features a 100 AMP panel, and an AC and heater outlet. Other features include an AC cutout, and a panel of plywood which may house a localization fiducial. There are two outlets for charging. The enclosure has a garage door with at least 14 inches of clearance away from its sidewall, but these measurements may be modified. The charging dock also has an outlet for the opener and a light switch, and a reinforced ceiling.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A method for autonomous persistent security, the method comprising:
receiving input from a user or control algorithm regarding an area to be patrolled with a plurality of Q-UGV systems, and;
providing coverage of said area to be patrolled using at least one of said Q-UGV systems,
communicating, through a wireless network, real time telemetry of said plurality of Q-UGV systems to a remote operation center, and;
interfacing at least said plurality of Q-UGV systems to a weatherproof enclosure with a charging dock,
charging a plurality of Q-UGV system using a wireless charging system inside of a weatherproof charging box, and wherein said charging system is capable of charging at a rate faster or equal to the rate of battery discharge of said Q-UGV.

2. The method according to claim 1, wherein said charging system services at least two UGVs.

3. The method according to claim 1, wherein said weatherproof charging system presents a wireless charging dock interface.

4. The method according to claim 1, wherein said enclosure features a powered door.

5. The method according to claim 1, wherein two Q-UGVs operate a charging sequence simultaneously.

6. The method according to claim 1, wherein said weatherproof charging box is equipped with a real time kinematic GPS base station.

7. The method according to claim 1, wherein a fiducial system tag is calibrated to said plurality of Q-UGV systems to provide identification and position of a weatherproof charging box's saddle to operate a docking and undocking sequence.

8. A method for autonomous persistent security, the method comprising:
receiving input from a user or control algorithm regarding an area to be patrolled with a plurality of Q-UGV systems, and;
providing coverage of said area to be patrolled to at least one of said Q-UGV systems,
communicating, through a wireless network, real time telemetry and control of at least one or more Q-UGV systems,
interfacing at least one of said Q-UGV systems to a weatherproof charging system independently without external commands from a remote operator,
charging at least one of said Q-UGV systems using a wireless charging system inside of a weatherproof charging box, and wherein said charging system is capable of charging at a rate faster or equal to the rate of battery discharge of said Q-UGV,
programming at least one of said Q-UGV systems to execute fully autonomous execution models, wherein said Q-UGV receives mission commands deriving from a wireless system or its onboard program memory, and;
executing, by way of a processor inside of a single board computer housed within said weatherproof charging box, commands deriving from said wireless system regarding said charging and docking of said Q-UGV.

9. The method according to claim 8, wherein said charging enclosure is equipped with a real time kinematic GPS base station.

10. The method according to claim 9, wherein said real time kinematic GPS base station provides GPS correction to a GNSS system within said Q-UGV system.

11. The method according to claim 8, wherein said autonomous execution models include operating said powered door.

12. The method according to claim 8, wherein two Q-UGVs may be operating simultaneously as part of a patrolling and charging mission.

13. A system for autonomous persistent security, the system comprising:
a charging enclosure, comprising of a wireless charging station housed inside of a charging enclosure with a battery interface, wherein said charging enclosure is reinforced with weather-proof materials, and maintains a 4G and LTE gateway, router and wireless communication system to interface with at least one Q-UGV,
a plurality of wireless charging dock affixed to said wireless charging station, wherein said wireless charging dock presents a wireless charging dock interface in communication with at least one Q-UGV,
an alternating current electrical unit, featuring a breaker panel for managing the flow of electricity within said charging enclosure, and an electrical disconnect, and;
a plurality of fiducial system tags, configured to mark, identify, and estimate the position of the dock interface saddle of said wireless charging system,
a single board computer housed within said charging enclosure, capable of receiving and executing tasks by way of a processor,
a powered garage door,
a heating unit for controlling temperatures of said wireless, charging dock,
and an overhead light, and;
a real time kinematic GPS base station for determining a location for said Q-UGV and said wireless charging station.

14. The system according to claim 13, wherein said charging enclosure is insulated and climate controlled for maintaining persistent operation of said Q-UGV's battery.

15. The system according to claim 13, wherein said fiducial system tag is installed inside of a plywood panel within said charging dock.

16. The system according to claim 13, wherein said overhead light may be triggered by a motion sensor.

17. A method for autonomous persistent security, the method comprising:
initializing a location of a Q-UGV system using a fiducial in a enclosure operating on a wireless network,
performing an undocking sequence in relation to a wireless charging dock in said enclosure,
closing an automated door, affixed to said enclosure,
initializing said Q-UGV system position in GPS coordinates through the use of internal and external sensors,
navigating a series of waypoints for said Q-UGV system to tread along a desired route,
returning said Q-UGV system back to said enclosure,
opening an automated door,
docking,
closing said automated door,
and beginning a charging operation of said Q-UGV system battery.

18. The method according to claim 17, wherein said enclosure further comprises of a single board computer.

19. The method according to claim 18, wherein said single board computer features a microprocessor and memory to operate on said network of said Q-UGV and said wireless charging dock.

20. The method according to claim 19, wherein said charging operation is used to charge a plurality of Q-UGV systems.
